(19) United States
(12) Patent Application Publication
(10) Pub. No.: US 2010/0054327 A1
(43) Pub. Date: Mar. 4, 2010

(54) Data Transcoding

(75) Inventor: Jonathan A. Capless, Bradford (GB)

Correspondence Address: DORSEY & WHITNEY LLP;on behalf of EchoStar Technologies, L.L.C., 370 Seventeenth St., Suite 4700, Denver, CO, 80202-5647, US

(73) Assignee: EchoStar Technologies L.L.C., Englewood, CO (US)

(21) Appl. No.: 12/201,928

(22) Filed: Aug. 29, 2008

(51) Int. Cl. H04B 1/66; H04N 7/173

(52) U.S. Cl. 375/240.01; 725/131

(57) ABSTRACT

A system and method for transcoding data, such as an audiovisual program, audio data or video data, from a first format to a second format. Systems may accept a first data file and transcode it to create a second data file in a different format. Transcoding may occur at a time other than the time at which the system receives the data file. The later transcoding time may be user-selected. The system may generate an icon or other indicator to signify the data has been marked for later transcoding.

### BACKGROUND OF THE INVENTION

1. Technical Field

This invention relates generally to media conversion, and more specifically to methods and apparatus for transcoding data from a first format to a second format.

2. Background Discussion

For many years, televisions have been the primary means for receiving and reviewing audiovisual content such as programs and movies. With the advent of relatively inexpensive, portable electronic content players, such as portable audio and video players, the review of content is rapidly becoming decoupled from the delivery of content. Modern content consumers desire the ability to review content at any time, from any place. To some extent, the Internet facilitates this model.

However, existing content distribution systems are both mature and robust. For example, millions of Americans have access to content via a satellite or cable distribution system; their primary programming is received in such a manner. Further, most satellite/cable operators may provide vastly more traditional audiovisual content than is available across the Internet; at least some of this content is exclusive an unavailable across any other distribution system.

Traditionally, content delivered across satellite/cable/broadcast distribution systems is viewed on a television and is not especially portable. This directly clashes with the aforementioned desire to view programs at different times (e.g., time-shifting) and/or in different places (e.g., place-shifting). As people become busier, time- and place-shifting becomes more important. Without such shifting, the market for content transmitted across the aforementioned distribution networks may have a diminished audience.

Accordingly, there is a need in the art for a method and system permitting a user to shift content received across a “traditional” distribution network.

### SUMMARY OF THE INVENTION

One embodiment of the present invention may take the form of a system for transcoding data, such as an audiovisual program, audio data or video data, from a first format to a second format. Thus, certain embodiments may accept a first data file and transcode it to create a second data file in a different format.

Such transcoding may occur, for example, in a set-top box of a satellite distribution system. The set-top box may transcode the file in accordance with one or more user-specified parameters or may employ default parameters. For example, the set-top box may transcode the file only at a certain time or upon turning off the set-top box. Through transcoding, the file may be rendered into a format suitable for transfer to and review on a portable electronic device such as a handheld gaming system, digital audio/video player, mobile telephone and so forth. Transcoding may likewise allow a user to time-shift or place-shift viewing of content.

Another embodiment takes the form of a method for transcoding a file, comprising the operations of: receiving a file; storing the file on a storage device associated with a set-top box; receiving an indication from a user that the file is to be transcoded at a selected time; in response to the indication, transcoding the file at the selected time to produce a transcoded file; and storing the transcoded file.

Still another embodiment takes the form of a transcoding apparatus, comprising: at least one tuner operative to receive a signal; a decoder connected to the tuner and operative to decode the signal into a data set; a storage device connected to the decoder and operative to digitally store the data set; and a processor operative to transcode the data set, thereby creating a transcoded data set.

Yet another embodiment takes the form of an electronic menu for an electronic program guide, comprising: a listing showing at least one program; a transcoding field displayed on the listing and corresponding to the at least one program, the transcoding field in a first state in the event the listing is not selected by a user; wherein the transcoding field is in a second state in the event the listing is selected by the user for transcoding; the transcoding field is in a third state in the event the corresponding at least one program is transcoded to produce a transcoded file; and the electronic menu is operative to be displayed on a display.

### BRIEF DESCRIPTION OF THE DRAWINGS

FIG. 1 depicts an exemplary operating environment for certain embodiments.

FIG. 2 depicts a first menu of an electronic program guide through which a user may select a program for transcoding.

FIG. 3 depicts a transcoding sub-menu accessible from the menu of FIG. 2.

FIG. 4 depicts the menu of FIG. 2, showing the presence of a transcoding icon.

FIG. 5 is a flowchart showing one sample method for transcoding a file.

### DETAILED DESCRIPTION OF THE INVENTION

One embodiment of the present invention may take the form of a system for transcoding data, such as an audiovisual program, audio data or video data, from a first format to a second format. Thus, certain embodiments may accept a first data file and transcode it to create a second data file in a different format. Alternatively, certain embodiments may transcode the first data file without creating a second data file, thus changing the initial file instead of creating another one. Accordingly, in such embodiments, a single file exists prior to the embodiment's transcoding operation and a single file exists afterward.

Through transcoding, the file may be rendered into a format suitable for transfer to and review on a portable electronic device such as a handheld gaming system, digital audio/video player, mobile telephone and so forth. Transcoding may likewise allow a user to time-shift or place-shift viewing of content.

“Transcoding,” as used herein, generally refers to digital-to-digital conversion of a file from one format to another. A “format,” as used herein, may refer to a bit rate, encoding or compression scheme (e.g., MP3, MP4, AAC and so forth), file size, picture or video size (e.g., 640×480 pixels), and so on. The transcoded file need not be encoded with a codec different than the one used to create the first file. Likewise, the term “file,” as used herein, refers to any packet, set or aggregate of digital data or information, particularly including digital media such as audiovisual programs, audio or video.

Transcoding may occur at a variety of times and may, in some embodiments, be user-scheduled. Alternatively, the embodiment may transcode one or more files while the embodiment is not otherwise in use or at non-peak times as determined by the embodiment or as specified by preset instruction. As one example, by monitoring usage patterns, the embodiment may determine that it typically is not otherwise in use during a specific period, such as 2:00 AM to 3:30 AM. The embodiment may thus schedule file transcoding to occur in this interval.

In addition, and as discussed in more detail below, the option to transcode a file may be selected from a menu provided by an electronic device, such as a set-top box. A user may, for example, interact with the set-top box (or other device) to select a file for transcoding. In response, the set-top box may mark or otherwise indicate the file is to be transcoded. The set-top box may, for example, display an icon next to the file name to signal to the user that the file has been selected for transcoding. The set-top box may also transcode the file at the appropriate time.

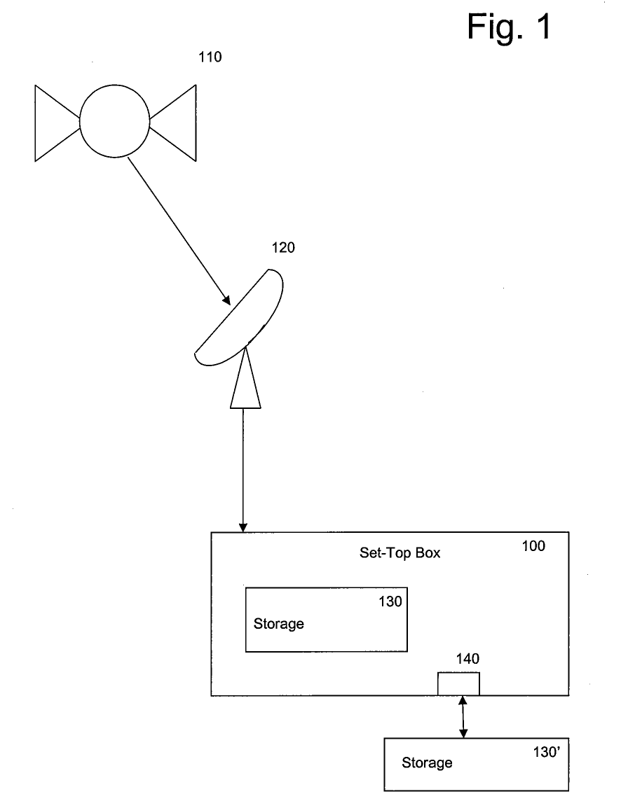

Generally, a file to be transcoded may be received from a satellite 110, as shown in FIG. 1. The file may be transmitted wirelessly as a data stream from the satellite to a receiver dish 120 located at a user's home or dwelling. In the case of multi-unit dwellings, a single receiver dish 120 may service multiple users.

The receiver dish 120 may incorporate a low-noise block converter or feedhorn that relays the signal to a tuner in a set-top box 100 located within a user's home. The set-top box generally demodulates the data (via a decoder) into a baseband signal, which may be processed as necessary to provide an output signal to a television for display.

Data, such as a file transmitted in or on the aforementioned signal, may be stored on a storage device 130 for later viewing or use. The data may be stored after being decoded and simultaneously with the provision of the data as an output signal. The storage device 130 may be any type of magnetic, optical, solid state or memory-based storage and is often (although not necessarily) integrated into the set-top box 100. Alternatively, the storage device 130 may communicate with the set-top box via a universal serial bus (USB) port 140 and cable or other computing interface or standard. Certain embodiments may include both a first storage device 130 integrated into the set-top box 100 and a second storage device 150 connected to the set-top box via an interface.

The operations of the satellite 110, receiver dish 120, storage devices 130, 150 and set-top box 100, except as provided elsewhere herein, are generally known to those of ordinary skill in the art. A processor or other control electronics may generally control the operation of the set-top box, including coordinating the transcoding, decoding, storage, playback and providing of an output signal for any given file, program or other data set.

It should be understood that the foregoing discussion of a file transmitted via satellite 110 and processed by a set-top box 100 is intended as an example only. The file may be transmitted from a cable headend across a wired connection to a cable box, received and transcoded by a computing device, transmitted across a network such as the Internet, an intranet, an internet, a wide-area network, a local-area network and so forth. Further, any electronic device capable of receiving and transcoding the file may operate in the manners generally described herein. As yet another non-limiting example, a television or audiovisual receiver may be configured to receive and transcode a file, often when coupled with an appropriate digital storage medium to store the first file and/or the transcoded second file.

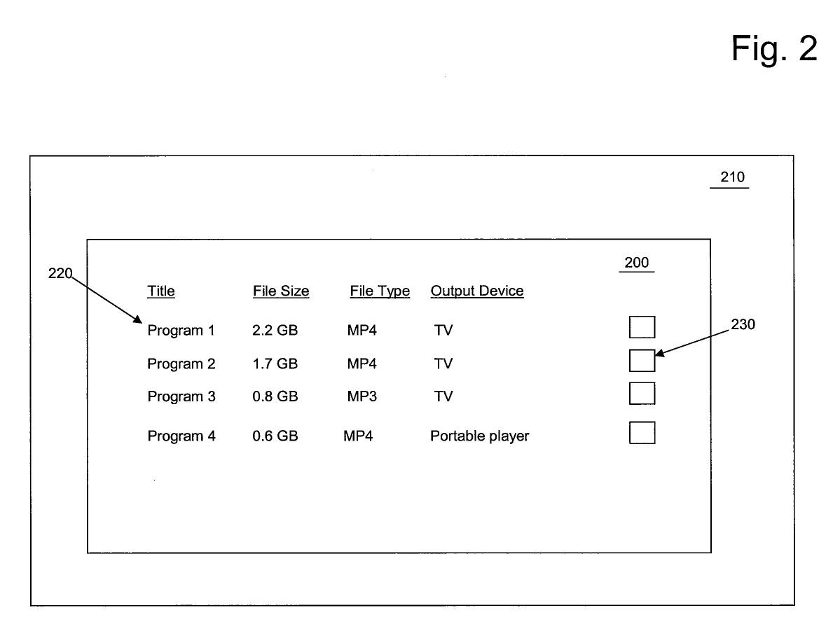

Certain embodiments may transcode or convert a file, for example a file stored on the storage device 130 of the set-top box 100, from a first format to a second format. A user may select or otherwise indicate the file which he desires to be transcoded and, in some embodiments, may also specify one or more parameters for the output (e.g., transcoded) file. An example of selecting a file for transcoding, as well as the transcoding procedure itself, will now be discussed with respect to FIGS. 2-4.

FIG. 2 generally depicts a first menu 200. The menu 200 may be displayed on a television or other suitable display 210, such as a computer monitor. The first menu 200 may be a portion of an electronic program guide, user interface or other instrument for managing functionality of the set-top box 100. In the present example, the first menu 200 may include a listing 220 of programs previously recorded by a user. The listing 220 may include a variety of information such as, but not limited to: a program name; a program file size; a program type (e.g., a compression scheme); an appropriate output device; and a transcoding selection box 230. It should be understood that the listing 220 may include additional information or may omit any of the information listed and/or shown herein.

The user may highlight, select or otherwise indicate a program for transcoding (collectively referred to herein as “selecting” a program). Such selection may be made, for example, by use of an appropriately configured remote control communicating with a receiver or transceiver within the set-top box 100. Such a transceiver may be operationally connected to the processor to pass user commands to the processor for execution. A single button or selection mechanism of the remote control may be dedicated to activating the transcoding function or the transcoding function may be selected from a menu or sub-menu shown in response to selecting the program. It should be understood that the terms “program” and “file” are generally used synonymously herein.

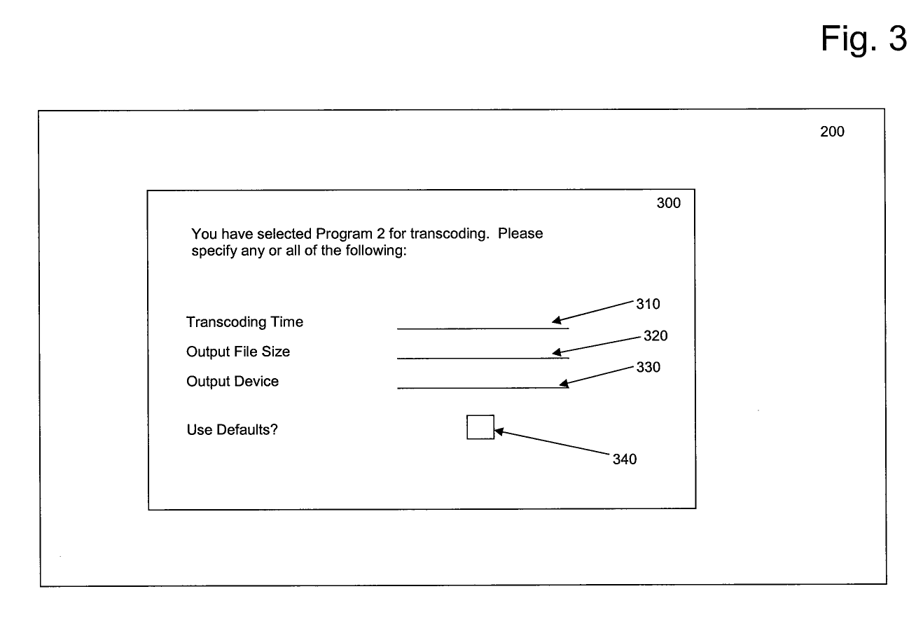

Continuing the example, FIG. 3 depicts a transcoding sub-menu that may be displayed once a user has selected a program for transcoding. The sub-menu 300 may include a message stating which program has been selected and instructing the user to specify one or more transcoding parameters. In the example of FIG. 3, as user may select or specify a transcoding time 310, an output file size 320, an output device 330 and/or a default configuration 340. Each of these parameters will be discussed in turn.

The user may specify a transcoding time 310 from the transcoding sub-menu 300. By specifying a time, the user may control when the transcoding operation takes place. In certain embodiments, transcoding of files may employ processor power that would otherwise be used to provide user functionality or control of the set-top box 100. Additionally, in certain embodiments it may not be possible to write to the storage device 130, 130′ during a transcoding operation. Accordingly, it may be advantageous for a user to specify the time at which the transcoding takes place, thereby avoiding resource conflicts.

A user may also specify an output file size field 320 value. The output file size may be the maximum size for a transcoded file. This may be useful, for example, when the user desires to store the transcoded file on a storage device 130, 130′ that has limited capacity, such as a flash drive, portable drive, music playing device (e.g., an IPOD), and so forth. The output file size field 320 is not necessarily the final size of the transcoded file but instead may be a maximum file size, such that a transcoded program will not exceed this value.

As yet another option, a user may specify an output device on which a transcoded program will be viewed or reviewed in the output device field 330. Certain output devices may have particular screen resolutions, video processing capabilities, and/or audio output capabilities that limit the fidelity of video and/or audio regardless of the format of the transcoded file. As an example, SONY's PSP portable device has a maximum screen resolution of 480 by 272 pixels. Thus, if a first transcoded file is formatted for a 1900 by 1200 pixel resolution, the file would likely show no better picture quality on playback than a similar second transcoded file formatted for 480 by 272 pixel resolution. The first transcoded file, however, would likely be significantly larger than the second transcoded file and thus take up more space on a storage device 130, 130′. (It should be noted that a portable storage device 130′ may be incorporated into another electronic device such as the aforementioned PSP portable or an MP3 player.) As yet another example, not all portable devices can play back audiovisual files encoded with DIVX or OGG compression schemes. Accordingly, by specifying a particular output device, the embodiment may select corresponding formats (resolution, playback rate, audio encoding, video encoding and so forth) to complement the capabilities of the output device, potentially including storage capacity. To facilitate such a selection, the embodiment may present a list of output devices from which the user may choose.

As an alternative to the foregoing, a user may select the “use defaults” field 340 (represented by a checkbox in FIG. 3). Selecting this field may cause the embodiment operate with a set of previously-specified default parameters. The default parameters may be user-specified or encoded into the hardware, software or firmware of the embodiment by the manufacturer, installer or seller. In certain embodiments, selecting the “use defaults” field 340 overrides and other specified transcoding parameters. In alternative embodiments, selecting this field may not override other specified parameters but may fill in those parameters left blank.

The transcoding sub-menu 300 may be displayed as an overlay on the first menu 200 or may replace the first menu 200. Likewise, the method of navigating between the first menu and transcoding sub-menu may vary between embodiments.

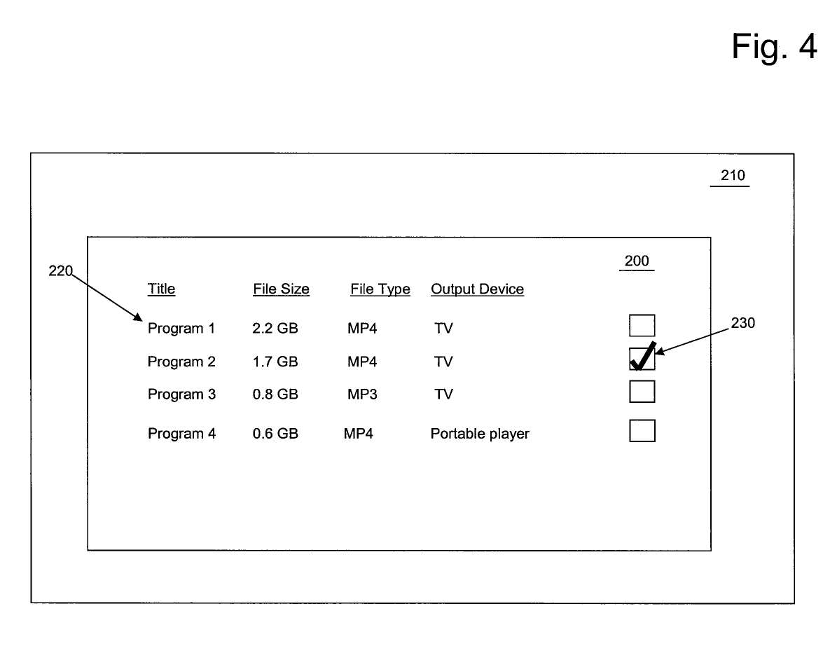

FIG. 4 depicts the first menu 200 after the transcoding sub-menu has been navigated and any parameters selected. As shown in FIG. 4, an icon may appear in the transcoding selection box 230 to indicate the corresponding program has been selected for transcoding. A similar icon may appear on other menus on which the program appears. For example, on a menu showing all of a user's recordings, files selected for transcoding may display the same or a similar icon. Further, once a program has been transcoded, a different icon may be displayed to indicate the operation is complete.

Transcoded files may be stored on an storage device 130 internal to the set-top box 100 or on an external storage device 130′. Further, the embodiment may facilitate the transfer of a file from internal storage to external storage. The option to transfer files (transcoded or otherwise) to external storage may appear when any external storage device 130′ is connected to the set-top box 100 or may be selected from an appropriate menu.

It should be noted that transcoding may also be selected by a user when the user designates that the program should be recorded, from example from an electronic program guide. That is, in certain embodiments the user may select a program to be recorded and transcoded from a single menu prior to the actual recording of the program. The embodiment may either transcode the program according to default or user-selected parameters, or may transcode the program as it is being recorded.

Certain embodiments may omit the selection of transcoding parameters and instead perform transcoding operations when the embodiment is idle, turned off or otherwise inactive. Alternatively, an embodiment may have a default time at which all transcoding is performed, possibly presuming the embodiment is not in operation at that time.

In the event a storage device 130 to which a transcoded file is written is full, the embodiment may discard other stored files to make room for the transcoded file. Certain embodiments may also discard the original, non-transcoded file upon completion of a transcoding operation.

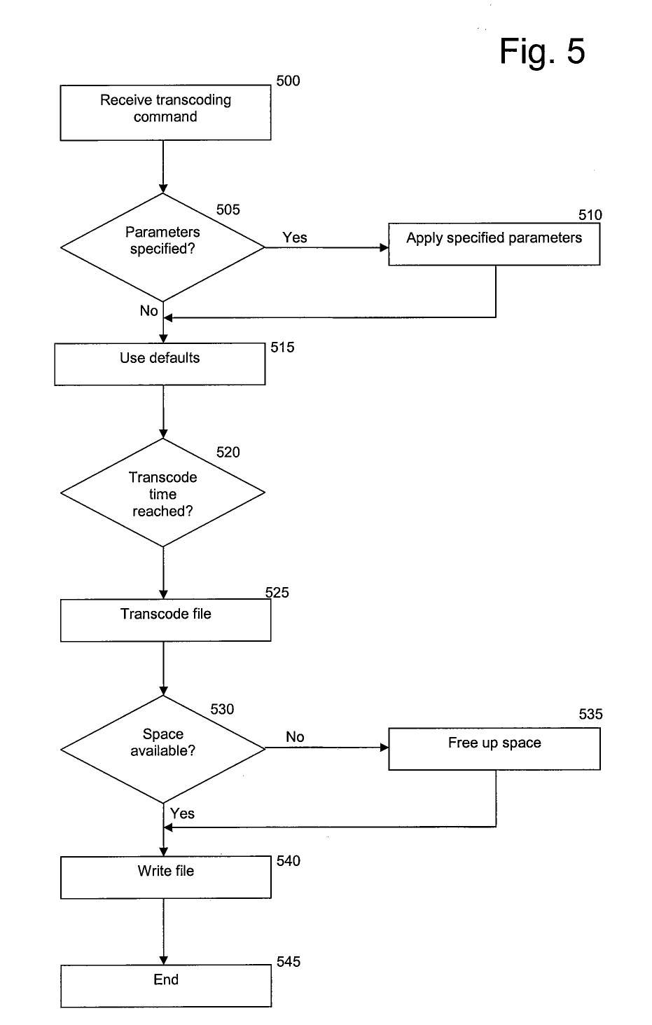

FIG. 5 is a flowchart showing one sample set of operations for an embodiment transcoding a file from a first format to a second format. Initially, in operation 500, the embodiment receives a transcoding command. In operation 505, the embodiment determines if any transcoding parameters are specified for the operation or output file (for example, through the transcoding sub-menu 300 shown in FIG. 3).

If transcoding parameters are specified, the embodiment proceeds to operation 510 and applies these one or more default parameters to the transcoding operation. If no such parameters are specified, however, the embodiment applies default values in operation 515. It should be noted that, following the application of specified parameters in operation 510, the embodiment generally proceeds to operation 515 to employ default parameters for any unspecified values. If all parameters are specified, operation 515 may be omitted.

In operation 520, the embodiment determines if the transcode time has been reached. If not, operation 520 is repeated until the proper time is at hand. Once the time is reached (whether default or specified), operation 525 is executed.

In operation 525, the embodiment transcodes the file according to the parameters set forth in operations 510-515. Following transcoding, the embodiment determines in operation 530 if storage space is available on the storage device 130, 130′ on which the transcoded file is to be stored. (It should be noted that a user may specify on which storage device a transcoded file is to be stored as a transcoding parameter.)

If no space is available, the embodiment executes operation 535 and frees up space on the storage device 130′. After operation 535, or in the event the embodiment determines space is available in operation 530, the embodiment executes operation 540 and writes the transcoded file to the storage device.

The method ends in end state 540.

It should be noted that certain operations may be omitted or added in various embodiments of the invention. For example, some embodiments may not permit user specification of transcoding parameters and thus may omit operations 505 and 510. Likewise, other embodiments may execute operations out of order; some embodiments may perform operations 530-540 prior to operation 525. Accordingly, it should be understood that the method of FIG. 5 is intended as a single, non-limiting example only.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

I claim:

1. A method for transcoding a file, comprising:
receiving a file;
storing the file on a storage device associated with a set-top box;
receiving an indication from a user that the file is to be transcoded at a selected time;
transcoding the file to produce a transcoded file at the selected time; and
storing the transcoded file.

2. The method of claim 1, wherein the transcoded file is stored on a second storage device.

3. The method of claim 2, wherein the second storage device is intermittently coupled with the set-top box.

4. The method of claim 3, wherein the second storage device is contained within a portable electronic device.

5. The method of claim 1, wherein the indication includes at least one transcoding parameter specified by the user.

6. The method of claim 5, wherein the at least one transcoding parameter is chosen from the group comprising: a transcoding start time; an output file size; and an output device.

7. The method of claim 1, further comprising the operation of:
in response to receiving the indication from the user, marking the entry in the menu with a second icon to indicate the transcoded file is to be produced

8. The method of claim 7, further comprising the operation of:
after transcoding the file, marking an entry in a menu with a first icon to indicate the transcoded file has been produced.

9. The method of claim 1, further comprising:
determining if a transcoding time is specified by the user; and
in the event a transcoding time is not specified by the user, transcoding the file to produce the transcoded file at a default time.

10. The method of claim 1, further comprising:
determining if a transcoding time is specified by the user; and
in the event a transcoding time is not specified by the user, transcoding the file to produce the transcoded file upon powering down the set-top box.

11. A transcoding apparatus, comprising:
at least one tuner operative to receive a signal;
at least one decoder connected to the at least one tuner and configured to decode the signal into a data set;
at least one storage device connected to the at least one decoder and configured to digitally store the data set;
at least one processor configured to transcode the data set to create a transcoded data set, further configured to cause an icon to be displayed on a display, the icon indicating the data set is to be transcoded.

12. The transcoding apparatus of claim 11, wherein the at least one storage device is removably coupled to the at least one decoder.

13. The transcoding apparatus of claim 12, wherein the transcoded data set is stored on the storage device.

14. The transcoding device of claim 11, further comprising a receiver operative to receive at least one transcoding parameter from a remote, the at least one transcoding parameter specifying a format of the transcoded data set.

15. The transcoding device of claim 11, wherein the processor is operative to delete the data set from the storage device upon creation of the transcoded data set.

16. The transcoding apparatus of claim 11, wherein the icon indicates that the data set is to be transcoded at the selected time.

16. An electronic menu for an electronic program guide, comprising:
a listing showing a program;
a transcoding field displayed on the listing and corresponding to the program, the transcoding field in a first state if the listing is not selected by a user; wherein
the transcoding field is in a second state in the event the listing is selected by the user for transcoding;
the transcoding field is in a third state in the event the corresponding program is transcoded to produce a transcoded file; and
the electronic menu is operative to be displayed on a display.

17. The menu of claim 16, wherein:
the second state of the transcoding field comprises displaying a first icon; and
the third state of the transcoding field comprises displaying a second icon.

18. The menu of claim 17, further comprising a transcoding sub-menu accessible and displayed upon selection of the at least one program by a user, the transcoding sub-menu comprising at least one selectable parameter corresponding to the transcoded file.

19. The menu of claim 18, wherein the at least one selectable parameter controls at least one aspect of the transcoded file.

20. The menu of claim 19, wherein the at least one selectable parameter is chosen from the group comprising: a transcoding time; an output file size; and an output device.
